(19) United States
(12) Patent Application Publication
(10) Pub. No.: US 2018/0258254 A1
(43) Pub. Date: Sep. 13, 2018

(54) NANOMATERIAL-BIOMASS FIBER COMPOSITE AND PREPARATION METHOD THEREOF

(71) Applicant: ZHEJIANG A & F UNIVERSITY, HANGZHOU (CN)

(72) Inventors: CHUNDE JIN, HANGZHOU (CN); JIAN LI, HANGZHOU (CN); QINGFENG SUN, HANGZHOU (CN)

(21) Appl. No.: 15/974,453

(22) Filed: May 8, 2018

Related U.S. Application Data
(63) Continuation-in-part of application No. PCT/CN2017/105498, filed on Oct. 10, 2017.

(30) Foreign Application Priority Data
Nov. 23, 2016 (CN) 201611047209.9

(51) Int. Cl. C08K 3/22; C08K 3/08; C08K 3/36; C08L 97/02; C08K 3/04

(52) U.S. Cl. CPC C08K 3/22; C08K 3/08; C08K 3/36; C08L 97/02; C08K 3/042; C08K 2003/265; C08K 3/041; C08K 2003/2241; C08K 2003/2296; C08K 2003/0806; C08K 2003/2275; C08K 3/046

(57) ABSTRACT

A nanomaterial-biomass fiber composite and preparation method thereof. The biomass fibers are cut or sliced, and then dried. The dried biomass fibers are mixed with a nanomaterial and conveyed to the preheating cylinder of a defibrator for cooking treatment. The cooked mixture is pushed between the grinding discs of the defibrator for hot grinding treatment. The resulting material is then hot pressed to obtain the nanomaterial-biomass fiber composite material. The preparation method benefits from simple operation, low cost, low energy consumption, suitability for industrialized production, and wide application prospect in the field of production of binderless fiberboard.

### RELATED APPLICATIONS

This application is a continuation-in-part application of the international application PCT/CN2017/105498 filed Oct. 10, 2017, which claims the benefit of the Chinese patent application CN201611047209.9 filed Nov. 23, 2016, each of which is incorporated herein by reference in its entirety.

### FIELD OF THE INVENTION

The invention relates to the technical field of composite materials, in particular to a nanomaterial-biomass fiber composite and a preparation method thereof.

### BACKGROUND OF THE INVENTION

Nanomaterials refer to materials that have at least one dimension in the three-dimensional space being in the nanoscale range (1-100 nm) or consist of them as basic units. Once the material's dimension enters the nanometer scale, the performance thereof has undergone a leap from quantitative change to qualitative change, resulting in new phenomena such as quantum size effect, small size effect, surface effect, and macroscopic quantum tunneling effect, and it obviously exhibits many new properties that are not only different from those of macroscopic objects but also different from those of single isolated atoms. Although the nanomaterials have not developed for a long time, they have been applied in all aspects and have also promoted the development of science and technology. Numerous studies have demonstrated that inorganic nanomaterials, especially crystalline nano metal oxides, can produce the effects such as light transmission, strength enhancement, water resistance, heat insulation, fire protection, sterilization and self-cleaning, and can be applied into material protection. For example, nano-ZnO has very strong UV shielding and infrared absorption effects, and can produce anti-aging and antibacterial effects; nano-Al₂O₃ and nano-SiO₂ mainly applied to optical single crystals and fine ceramics have excellent hardness, wear resistance and toughening effect, and can significantly improve strength and toughness thereof; nano-CaCO₃ is a widely used reinforcing agent capable of increasing the hardness and stiffness; and nano-TiO₂ having a strong photo-catalytic activity can play a role in decomposing organic pollutants, purifying air and sterilizing and self-cleaning. At the same time, nano-TiO₂, nano-ZnO, nano-SiO₂, nano-Al₂O₃ and nano-Fe₂O₃ are also excellent anti-aging agents.

Biomass fiber is an essential material for the production of binderless fiberboards. The existing fiber processing method for the production of binderless fiberboard is relatively single, i.e., carrying out softening and hydrolysis treatment by only acidifying or alkalizing in the preheating cylinder of a defibrator, hot grinding and separating the hydrolyzed raw materials into wet fibers, and then carrying out a series of process operations. There are many defects in the existing production of binderless fiberboards such as low bonding strength, high density, high brittleness, and easy water absorption.

The existing technology for adding nano-particles into a fiberboard is mainly a sol-gel method, wherein pre-prepared nanoscale sol particles can be introduced into lignocellulose cells to composite with the cellulose on the cell wall, and polycondensation or dehydration usually occurs. Part of the sol is filled in a large capillary system dominated by cell cavities, at this time, the gel is only filling body, part of the sol particles penetrate into the wood fiber cell wall, and the hydroxyl of the sol can be condensed with the cellulose hydroxyl of the cell wall to form chemical bonding; and at the same time, the hydroxyl groups of the sol itself also condense to form a cross-linked network, which is filled in the pores of the lignocellulose cell wall to achieve the purpose of compositing. However, the size of the fiber in the existing fiberboards with nano-particles added is relatively large, and the specific surface area of the fiber is so small that the internal fiber bonding is not closely enough, resulting in problems such as lower strength and larger thickness swelling rate of water absorption. In addition, as disclosed in CN 104262982 A and CN 101745967 A, it is necessary to add additional auxiliaries and adhesives into the fiberboards with nano-particles added to achieve sufficient strength, which not only makes the preparation process complicated, but also causes the problem of formaldehyde emission from the products.

Therefore, people have been committed to the development of new fiber materials to produce binderless fiberboard products with nano-particles added.

### OBJECTS AND SUMMARY OF THE INVENTION

In view of the defects in the prior art, the object of the present invention is to provide a nanomaterial-biomass fiber composite and a preparation method thereof, so as to provide a fiber material with excellent properties.

The present invention provides a nanomaterial-biomass fiber composite, the composite is prepared by cutting or slicing biomass fibers and drying; mixing the dried biomass fibers with a nanomaterial, and conveying them to the preheating cylinder of a defibrator for cooking treatment; and pushing the cooked mixture between the grinding discs of the defibrator for hot grinding treatment, and then hot pressing the resulting material to obtain the nanomaterial-biomass fiber composite.

The nanomaterial-biomass fiber composite material according to the present invention, wherein the biomass fiber is selected from one or more of wood and bamboo and their processing residues, crop waste, and Gramineae weed. As described herein, the crop waste is one or more of rice straw, wheat straw, corn straw, cotton straw and bagasse; and the Gramineae weed is reed and/or miscanthus.

The nanomaterial-biomass fiber composite material according to the present invention, wherein the nanomaterial is selected from one or more of nano-TiO₂, nano-ZnO, nano-Ag, nano-SiO₂nano-Fe₃O₄, nano-CaCO₃, nano-Al₂O₃, nano-Mg(OH)₂, nano-Al(OH)₃, nano-CeO₂, nano-MnO₂, nano-cellulose, nano-graphene, nano-carbon fiber and carbon nanotube. Preferably, the weight of the nanomaterial accounts for 0.01%-20% of the absolute dry weight of the biomass fiber.

The nanomaterial-biomass fiber composite material according to the present invention, wherein the composite is free of adhesive.

The nanomaterial-biomass fiber composite material according to the present invention, wherein the composite material is free of auxiliary agent. As described herein, the auxiliary agent refers to any material or additive other than the biomass fiber and the nanomaterial.

The present invention also provides a preparation method of the nanomaterial-biomass fiber composite comprising the steps of:
(1) cutting or slicing the biomass fiber, and then drying it to the extent that the moisture content of the biomass fibers is less than 10%;
(2) mixing the dried biomass fiber with a nanomaterial to obtain a mixture, and conveying the mixture to the preheating cylinder of a defibrator for cooking treatment;
(3) pushing the cooked mixture between the grinding discs of the defibrator for hot grinding treatment to obtain a slurry of a nanomaterial-biomass fiber composite; and
(4) filtering the hot-grinded slurry followed by paving it into a plate blank, and hot pressing the plate blank to obtain a nanomaterial-biomass fiber composite.

Preferably, in the step (2), the cooking temperature is 100-250° C., the steam pressure is 0.01-10 Mpa, and the cooking time is 1-60 min.

Preferably, in the step (3), the rotating speed for the hot grinding treatment is 500-3000 rpm, and the time for the hot grinding treatment is 1-24 h. During the hot grinding treatment of the step (3), due to that the mechanical energy produces heat, with hot grinding at a rotating speed of 500-3000 rpm for 1-24 hours, the temperature which the mixture reaches can exactly cause the physical changes such as splitting, deformation, and volume thinning of the wood fiber; and as the wood fiber size becomes smaller gradually and the specific surface area increases continuously, energy conversion occurs and the internal structure, physicochemical properties as well as chemical reaction activity also correspondingly changes, creating the best conditions for the compositing of wood fibers with nano-particles.

Preferably, in the step (4), the hot pressing temperature is 100-220° C., the hot pressing time is 10-300 min, and the hot pressing pressure is 1-8 MPa.

Optionally, mixing the dried biomass fiber with the nanomaterial is carried out by directly adding the nanomaterial to the dried biomass fiber and mixing them.

Optionally, mixing the dried biomass fiber with the nanomaterial is carried out by conveying the nanomaterial to the discharge valve of the defibrator via a pipe and injecting it into the discharge valve via a nozzle so as to mix it with the biomass fiber.

Optionally, mixing the dried biomass fiber with the nanomaterial is carried out by conveying the nanomaterial onto a wood chip at the feed inlet of the grinding chamber of the defibrator via a delivery pump, and conveying it into the continuous discharge valve of the grinding chamber of the defibrator via a gear pump so as to mix it with the biomass fiber.

In order to further improve the mechanical properties of the composite of the present invention, the preparation method may further comprises adjusting the pH value of the cooked mixture to 1-14 before carrying out the hot grinding treatment in the step (3).

The present invention also provides a nanomaterial-biomass fiber composite, which is prepared by the preparation method provided according to the present invention.

The present invention utilizes the mechanical force in the hot grinding process, to not only cause the physical changes such as splitting, deformation, and volume thinning of the wood fiber, but also as the wood fiber size becomes smaller gradually and the specific surface area increases continuously, produce energy conversion and correspondingly change in the internal structure, physicochemical properties as well as chemical reaction activity, creating the conditions for the compositing of wood fibers with previously prepared nano-particles. Because of the cross-linking reaction of furfural generated during the cooking and hot grinding process of the wood fiber with water molecule, the binderless fiber composite satisfying the mechanical properties can be prepared without adding an adhesive in the subsequent hot pressing process.

It can be known from the above technical solution, the present invention utilizes a hot grinding method to uniformly attach nanomaterials to biomass fibers, so as to prepare a nanomaterial-biomass fiber composite. The preparation method of the invention has the advantages of simple operation, low cost, low energy consumption, suitability for industrialized production, and wide application prospect in the field of production of binderless fiberboards.

### BRIEF DESCRIPTION OF FIGURES

In order to more clearly illustrate the specific embodiments of the present invention or the technical solutions in the prior art, the drawings used in the description of the specific embodiments or the prior art will be briefly described below. In all the figures, similar elements or parts are generally identified by similar reference numerals. In the drawings, various elements or parts are not necessarily drawn to actual scale.

FIG. 1 shows a flow chart of a preparation method of a nanomaterial-biomass fiber composite the examples of the present invention;

FIG. 2 is a scanning electron micrograph of a TiO₂ nanomaterial-biomass fiber composite prepared in Example 1 of the present invention;

FIG. 3 is a scanning electron micrograph of a ZnO nanomaterial-biomass fiber composite prepared in Example 2 of the present invention;

FIG. 4 is a scanning electron micrograph of a Fe₃O₄ nanomaterial-biomass fiber composite prepared in Example 5 of the present invention;

FIG. 5 is a scanning electron micrograph of a CaCO₃ nanomaterial-biomass fiber composite prepared in Example 6 of the present invention;

FIG. 6 is a hysteresis loop of a Fe₃O₄ nanomaterial-biomass fiber composite prepared in Example 5 of the present invention;

FIG. 7 is a graph showing the changing of the reflection loss frequency of the ZnO nanomaterial-biomass fiber composite prepared in Example 2 of the present invention; and

FIGS. 8A and 8B show a comparison of the mechanical properties between the binderless fiberboard prepared in Example 11 of the present invention and a conventional binderless fiberboard.

### DETAILED DESCRIPTION OF THE EMBODIMENTS

The examples of the inventive technical solution will be described in detail below with reference to the accompanying drawings. The following examples are merely used for more clearly explaining the technical solution of the present invention, and therefore, they are only examples, and cannot be used to limit the protection scope of the present invention.

It should be noted that, the technical terms or scientific terms used in this application shall be understood in the ordinary sense as understood by a person skilled in the art to which the present invention belongs unless otherwise specified.

The preparation method of a nanomaterial-biomass fiber composite provided by the present invention utilizes a hot grinding method to uniformly attach nanomaterials to biomass fibers, so as to prepare the nanomaterial-biomass fiber composite.

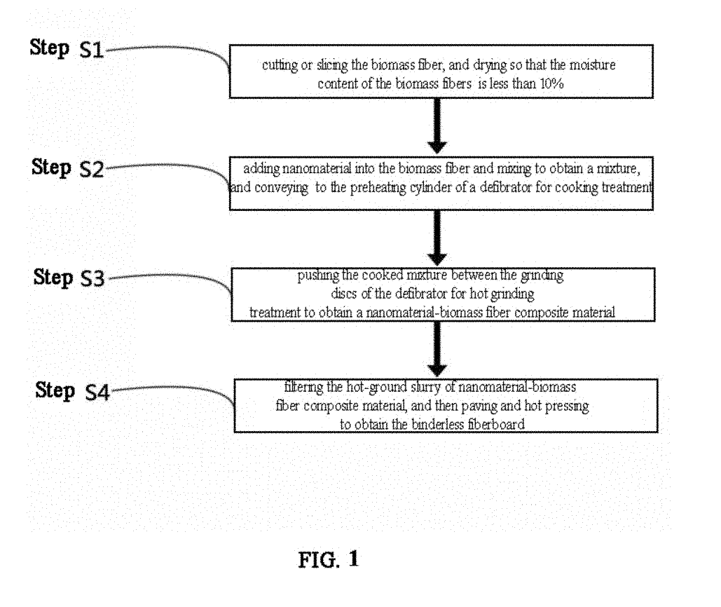

FIG. 1 shows a flow chart of a preparation method of a nanomaterial-biomass fiber composite provided by the present invention. Referring to FIG. 1, the preparation method comprises the steps of:

Step S1: cutting or slicing the biomass fiber, and then drying to the extent that the moisture content of the biomass fibers is less than 10%. As described herein, the biomass fiber includes wood, bamboo and their corresponding processing residues, crop waste, and Gramineae weed, the crop waste comprises rice straw, wheat straw, corn straw, cotton straw and bagasse, and the Gramineae weed comprises reed and/or miscanthus.

Step S2: mixing the dried biomass fiber with a nanomaterial to obtain a mixture, and conveying the mixture to the preheating cylinder of a defibrator for cooking treatment. Wherein, the cooking temperature in the preheating cylinder may be 100-250° C., the steam pressure may be 0.01-10 Mpa, the cooking time may be 1-60 min, and the nanometer material may include nano-TiO₂, nano-ZnO, nano-Ag, nano-SiO₂, nano-Fe₃O₄, nano-CaCO₃, nano-Al₂O₃, nano-Mg(OH)₂, nano-Al(OH)₃, nano-CeO₂, nano-MnO₂, nano-cellulose, nano-graphene, nano-carbon fiber and carbon nanotube. The nanomaterial may account for 0.01%-20% of the absolute dry weight of the biomass fiber.

Step S3: pushing the cooked mixture between the grinding discs of the defibrator for hot grinding treatment to obtain a slurry of nanomaterial-biomass fiber composite material.

Step S4: filtering the hot-ground slurry followed by paving it into a plate blank, and hot pressing the plate blank to obtain the nanomaterial-biomass fiber composite material. Preferably, the hot pressing temperature is 100-220° C., the hot pressing time is 10-300 min, and the hot pressing pressure is 1-8 MPa. In an embodiment of the present invention, the size of the board blank is 20 cm×20 cm×6 cm.

According to the preparation method of the present invention, mixing the dried biomass fiber with the nanomaterial is carried out by directly adding the nanomaterial to the dried biomass fiber and mixing them.

According to the preparation method of the present invention, mixing the dried biomass fiber with the nanomaterial is carried out by conveying the nanomaterial to the discharge valve of the defibrator via a pipe and injecting it into the discharge valve via a nozzle so as to be mixed with the biomass fiber.

According to the preparation method of the present invention, mixing the dried biomass fiber with the nanomaterial is carried out by conveying the nanomaterial onto a wood chip at the feed inlet of the grinding chamber of the defibrator via a delivery pump, and conveying it into the continuous discharge valve of the grinding chamber of the defibrator via a gear pump so as to be mixed with the biomass fiber.

According to the preparation method of the present invention, the pH value of the cooked mixture is adjusted to 1-14 before carrying out the hot grinding treatment. This can increase the surface activity of the fiber and improve its compositing efficiency with the nano-particles. Specifically, the pH value of the cooked mixture may be adjusted with an aqueous solution of H₃PO₄, HCl, H₂SO₄ or NaOH.

The present invention also provides a nanomaterial-biomass fiber composite, which is prepared according to the preparation method of the present invention.

The preparation method of a nanomaterial-biomass fiber composite material provided by the present invention utilizes a hot grinding method to uniformly attach nanomaterials to biomass fibers with firm attachment, so as to prepare the nanomaterial-biomass fiber composite. The preparation method of the invention has the advantages of simple operation, low cost, low energy consumption, suitability for industrialized production, and wide application prospect in the field of production of binderless fiberboards.

The present invention composites nanomaterials with biomass fibers to endow the new composite with the excellent properties of nanomaterials, which not only can effectively improve and increase product properties such as anti-corrosion, flame retardancy, dimensional stability and wear resistance, ensure the reliability and safety in use of products, prolong service life, save resources and energy, and reduce environmental pollution; but can also endow the product with new properties, such as antibacterial property, self-cleaning, self-degradation, organics-containing, etc., thereby preparing a new type of high value-added functional binderless fiberboard and vigorously promoting the development of binderless fiberboard industry.

The preparation method of the present invention can overcome the technical problems of low bonding strength, high density, high brittleness and easy water absorption in the traditional binderless fiberboards; and enhance the flexibility and waterproof performance of the binderless fiber composite; and at the same time, the present invention is simple in operation, low in cost, low in energy consumption, and suitable for industrialized production.

The following several examples are provided with respect to the preparation method of the nanoparticle-fiber composite of the present invention. The defibrator used in the examples was purchased from Shanghai Shenou General Valve Industry Co., Ltd. in a model number of JM-L80.

### EXAMPLE 1

1. Cutting or slicing the biomass fiber, and then drying it to the extent that the moisture content of the biomass fiber is less than 10%, wherein the biomass fiber is wood;

2. adding nanomaterial into the biomass fiber and mixing them to obtain a mixture, and conveying the mixture to the preheating cylinder of a defibrator for cooking treatment, wherein the cooking temperature in the preheating cylinder is 100° C., the steam pressure is 0.01 MPa and the cooking time is 1 min; the nanomaterial is nano-TiO₂, and the nanomaterial accounts for 0.01% of the absolute dry weight of the biomass fiber; and wherein the pH value of the cooked mixture is adjusted to 1 using H₃PO₄ aqueous solution before carrying out the hot grinding treatment;

3. pushing the cooked mixture between the grinding discs of the defibrator for hot grinding treatment, wherein the rotating speed for the hot grinding is 2880 rpm, and the time for the hot grinding treatment is 6 h; and

4. filtering the hot-ground slurry followed by paving it into a plate blank, and hot pressing the plate blank to obtain the nanomaterial-biomass fiber composite, wherein the hot pressing temperature is 100° C., the hot pressing time is 270 min, and the hot pressing pressure is 7 MPa.

### EXAMPLE 2

1. Cutting or slicing the biomass fiber, and then drying it to the extent that the moisture content of the biomass fiber is less than 10%, wherein the biomass fiber is bamboo;

2. conveying the nanomaterial to the discharge valve of the defibrator via a pipe and injecting it into the discharge valve via a nozzle so as to be mixed with the biomass fiber to obtain a mixture, and conveying the mixture to the preheating cylinder of the defibrator for cooking treatment, wherein the cooking temperature in the preheating cylinder is 110° C., the steam pressure is 0.02 MPa and the cooking time is 2 min; the nanomaterial is nano-ZnO, and the nanomaterial accounts for 0.02% of the absolute dry weight of the biomass fiber; and wherein the pH value of the cooked mixture is adjusted to 2 using HC1 aqueous solution before carrying out the hot grinding treatment;

3. pushing the cooked mixture between the grinding discs of the defibrator for hot grinding treatment, wherein the rotating speed for the hot grinding is 2880 rpm, and the time for the hot grinding treatment is 6 h; and

4. filtering the hot-ground slurry followed by paving it into a plate blank, and hot pressing the plate blank to obtain the nanomaterial-biomass fiber composite, wherein the hot pressing temperature is 120° C., the hot pressing time is 100 min, and the hot pressing pressure is 8 MPa.

### EXAMPLE 3

1. Cutting or slicing the biomass fiber, and then drying it to the extent that the moisture content of the biomass fiber is less than 10%, wherein the biomass fiber is wood and its processing residues;

2. conveying the nanomaterial onto a wood chip at the feed inlet of the grinding chamber of the defibrator via a delivery pump, conveying it into the continuous discharge valve of the grinding chamber of the defibrator via a gear pump to be mixed with the biomass fiber to obtain a mixture, and conveying the mixture to the preheating cylinder of the defibrator for cooking treatment, wherein the cooking temperature in the preheating cylinder is 120° C., the steam pressure is 0.05 MPa and the cooking time is 4 min; the nanomaterial is nano-Ag, and the nanomaterial accounts for 0.04% of the absolute dry weight of the biomass fiber; and wherein the pH value of the cooked mixture is adjusted to 3 using H₂SO₄ aqueous solution before carrying out the hot grinding treatment;

3. pushing the cooked mixture between the grinding discs of the defibrator for hot grinding treatment, wherein the rotating speed for the hot grinding is 2880 rpm, and the time for the hot grinding treatment is 6 h; and

4. filtering the hot-ground slurry followed by paving it into a plate blank, and hot pressing the plate blank to obtain the nanomaterial-biomass fiber composite, wherein the hot pressing temperature is 200° C., the hot pressing time is 20 min, and the hot pressing pressure is 6 MPa.

### EXAMPLE 4

1. Cutting or slicing the biomass fiber, and then drying it to the extent that the moisture content of the biomass fiber is less than 10%, wherein the biomass fiber is bamboo and its processing residues;

2. adding nanomaterial into the biomass fiber and mixing them to obtain a mixture, and conveying the mixture to the preheating cylinder of a defibrator for cooking treatment, wherein the cooking temperature in the preheating cylinder is 130° C., the steam pressure is 0.1 MPa and the cooking time is 6 min; the nanomaterial is nano-SiO₂, and the nanomaterial accounts for 0.05% of the absolute dry weight of the biomass fiber; and wherein the pH value of the cooked mixture is adjusted to 4 using H₃PO₄ aqueous solution before carrying out the hot grinding treatment;

3. pushing the cooked mixture between the grinding discs of the defibrator for hot grinding treatment, wherein the rotating speed for the hot grinding is 2880 rpm, and the time for the hot grinding treatment is 6 h; and

4. filtering the hot-ground slurry followed by paving it into a plate blank, and hot pressing the plate blank to obtain the nanomaterial-biomass fiber composite, wherein the hot pressing temperature is 150° C., the hot pressing time is 120 min, and the hot pressing pressure is 5 MPa.

### EXAMPLE 5

1. Cutting or slicing the biomass fiber, and then drying it to the extent that the moisture content of the biomass fiber is less than 10%, wherein the biomass fiber is crop waste, specifically rice straw;

2. conveying the nanomaterial to the discharge valve of the defibrator via a pipe and injecting it into the discharge valve via a nozzle so as to be mixed with the biomass fiber to obtain a mixture, and conveying the mixture to the preheating cylinder of the defibrator for cooking treatment, wherein the cooking temperature in the preheating cylinder is 140° C., the steam pressure is 0.2 MPa and the cooking time is 10 min; the nanomaterial is nano-Fe₃O₄, and the nanomaterial accounts for 0.1% of the absolute dry weight of the biomass fiber; and wherein the pH value of the cooked mixture is adjusted to 5 using HCl before carrying out the hot grinding treatment;

3. pushing the cooked mixture between the grinding discs of the defibrator for hot grinding treatment, wherein the rotating speed for the hot grinding is 2880 rpm, and the time for the hot grinding treatment is 6 h; and

4. filtering the hot-ground slurry followed by paving it into a plate blank, and hot pressing the plate blank to obtain the nanomaterial-biomass fiber composite, wherein the hot pressing temperature is 180° C., the hot pressing time is 100 min, and the hot pressing pressure is 3 MPa.

### EXAMPLE 6

1. Cutting or slicing the biomass fiber, and then drying it to the extent that the moisture content of the biomass fiber is less than 10%, wherein the biomass fiber is crop waste, specifically wheat straw;

2. conveying the nanomaterial onto a wood chip at the feed inlet of the grinding chamber of the defibrator via a delivery pump, conveying it into the continuous discharge valve of the grinding chamber of the defibrator via a gear pump to be mixed with the biomass fiber to obtain a mixture, and conveying the mixture to the preheating cylinder of the defibrator for cooking treatment, wherein the cooking temperature in the preheating cylinder is 150° C., the steam pressure is 0.5 MPa and the cooking time is 12 min; the nanomaterial is nano-CaCO₃, and the nanomaterial accounts for 0.2% of the absolute dry weight of the biomass fiber; and wherein the pH value of the cooked mixture is adjusted to 6 using H₂SO₄ aqueous solution before carrying out the hot grinding treatment;

3. pushing the cooked mixture between the grinding discs of the defibrator for hot grinding treatment, wherein the rotating speed for the hot grinding is 2880 rpm, and the time for the hot grinding treatment is 6 h; and

4. filtering the hot-ground slurry followed by paving it into a plate blank, and hot pressing the plate blank to obtain the nanomaterial-biomass fiber composite, wherein the hot pressing temperature is 220° C., the hot pressing time is 20 min, and the hot pressing pressure is 7 MPa.

### EXAMPLE 7

1. Cutting or slicing the biomass fiber, and then drying it to the extent that the moisture content of the biomass fiber is less than 10%, wherein the biomass fiber is crop waste, specifically corn straw;

2. adding nanomaterial into the biomass fiber and mixing them to obtain a mixture, and conveying the mixture to the preheating cylinder of a defibrator for cooking treatment, wherein the cooking temperature in the preheating cylinder is 160° C., the steam pressure is 0.8 MPa and the cooking time is 15 min; the nanomaterial is nano-Al₂O₃, and the nanomaterial accounts for 0.4% of the absolute dry weight of the biomass fiber; and wherein the pH value of the cooked mixture is adjusted to 7 using H₃PO₄ aqueous solution and NaOH aqueous solution before carrying out the hot grinding treatment;

3. pushing the cooked mixture between the grinding discs of the defibrator for hot grinding treatment, wherein the rotating speed for the hot grinding is 2880 rpm, and the time for the hot grinding treatment is 6 h; and

4. filtering the hot-ground slurry followed by paving it into a plate blank, and hot pressing the plate blank to obtain the nanomaterial-biomass fiber composite, wherein the hot pressing temperature is 160° C., the hot pressing time is 180 min, and the hot pressing pressure is 4 MPa.

### EXAMPLE 8

1. Cutting or slicing the biomass fiber, and then drying it to the extent that the moisture content of the biomass fiber is less than 10%, wherein the biomass fiber is crop waste, specifically cotton straw;

2. conveying the nanomaterial to the discharge valve of the defibrator via a pipe and injecting it into the discharge valve via a nozzle so as to be mixed with the biomass fiber to obtain a mixture, and conveying the mixture to the preheating cylinder of the defibrator for cooking treatment, wherein the cooking temperature in the preheating cylinder is 170° C., the steam pressure is 1 MPa and the cooking time is 20 min; the nanomaterial is nano-Mg(OH)₂, and the nanomaterial accounts for 0.5% of the absolute dry weight of the biomass fiber; and wherein the pH value of the cooked mixture is adjusted to 8 using NaOH aqueous solution before carrying out the hot grinding treatment;

3. pushing the cooked mixture between the grinding discs of the defibrator for hot grinding treatment, wherein the rotating speed for the hot grinding is 2880 rpm, and the time for the hot grinding treatment is 6 h; and

4. filtering the hot-ground slurry followed by paving it into a plate blank, and hot pressing the plate blank to obtain the nanomaterial-biomass fiber composite, wherein the hot pressing temperature is 160° C., the hot pressing time is 180 min, and the hot pressing pressure is 4 MPa.

### EXAMPLE 9

1. Cutting or slicing the biomass fiber, and then drying it to the extent that the moisture content of the biomass fiber is less than 10%, wherein the biomass fiber is crop waste, specifically bagasse;

2. conveying the nanomaterial onto a wood chip at the feed inlet of the grinding chamber of the defibrator via a delivery pump, conveying it into the continuous discharge valve of the grinding chamber of the defibrator via a gear pump to be mixed with the biomass fiber to obtain a mixture, and conveying the mixture to the preheating cylinder of the defibrator for cooking treatment, wherein the cooking temperature in the preheating cylinder is 180° C., the steam pressure is 1.5 MPa and the cooking time is 25 min; the nanomaterial is nano-Al(OH)₃, and the nanomaterial accounts for 1% of the absolute dry weight of the biomass fiber; and wherein the pH value of the cooked mixture is adjusted to 9 using NaOH aqueous solution before carrying out the hot grinding treatment;

3. pushing the cooked mixture between the grinding discs of the defibrator for hot grinding treatment, wherein the rotating speed for the hot grinding is 2880 rpm, and the time for the hot grinding treatment is 6 h; and

4. filtering the hot-ground slurry followed by paving it into a plate blank, and hot pressing the plate blank to obtain the nanomaterial-biomass fiber composite, wherein the hot pressing temperature is 160° C., the hot pressing time is 180 min, and the hot pressing pressure is 4 MPa.

### EXAMPLE 10

1. Cutting or slicing the biomass fiber, and then drying it to the extent that the moisture content of the biomass fiber is less than 10%, wherein the biomass fiber is Gramineae weed, specifically reed;

2. adding nanomaterial into the biomass fiber and mixing them to obtain a mixture, and conveying the mixture to the preheating cylinder of a defibrator for cooking treatment, wherein the cooking temperature in the preheating cylinder is 190° C., the steam pressure is 2 MPa and the cooking time is 30 min; the nanomaterial is nano-CeO₂, and the nanomaterial accounts for 2% of the absolute dry weight of the biomass fiber; and wherein the pH value of the cooked mixture is adjusted to 10 using NaOH aqueous solution before carrying out the hot grinding treatment;

3. pushing the cooked mixture between the grinding discs of the defibrator for hot grinding treatment, wherein the rotating speed for the hot grinding is 2880 rpm, and the time for the hot grinding treatment is 6 h; and

4. filtering the hot-ground slurry followed by paving it into a plate blank, and hot pressing the plate blank to obtain the nanomaterial-biomass fiber composite, wherein the hot pressing temperature is 160° C., the hot pressing time is 180 min, and the hot pressing pressure is 4 MPa.

### EXAMPLE 11

1. Cutting or slicing the biomass fiber, and then drying it to the extent that the moisture content of the biomass fiber is less than 10%, wherein the biomass fiber is Gramineae weed, specifically miscanthus;

2. conveying the nanomaterial to the discharge valve of the defibrator via a pipe and injecting it into the discharge valve via a nozzle so as to be mixed with the biomass fiber to obtain a mixture, and conveying the mixture to the preheating cylinder of the defibrator for cooking treatment, wherein the cooking temperature in the preheating cylinder is 200° C., the steam pressure is 3 MPa and the cooking time is 40 min; the nanomaterial is nano-MnO₂, and the nanomaterial accounts for 5% of the absolute dry weight of the biomass fiber; and wherein the pH value of the cooked mixture is adjusted to 11 using NaOH aqueous solution before carrying out the hot grinding treatment;

3. pushing the cooked mixture between the grinding discs of the defibrator for hot grinding treatment, wherein the rotating speed for the hot grinding is 2880 rpm, and the time for the hot grinding treatment is 6 h; and

4. filtering the hot-ground slurry followed by paving it into a plate blank, and hot pressing the plate blank to obtain the nanomaterial-biomass fiber composite (i.e., binderless fiberboard), wherein the hot pressing temperature is 160° C., the hot pressing time is 180 min, and the hot pressing pressure is 4 MPa.

### EXAMPLE 12

1. Cutting or slicing the biomass fiber, and then drying it to the extent that the moisture content of the biomass fiber is less than 10%, wherein the biomass fiber comprises a mixture of wood and wood processing residues;

2. conveying the nanomaterial onto a wood chip at the feed inlet of the grinding chamber of the defibrator via a delivery pump, conveying it into the continuous discharge valve of the grinding chamber of the defibrator via a gear pump to be mixed with the biomass fiber to obtain a mixture, and conveying the mixture to the preheating cylinder of the defibrator for cooking treatment, wherein the cooking temperature in the preheating cylinder is 210° C., the steam pressure is 5 MPa and the cooking time is 45 min; the nanomaterial is nano-cellulose, and the nanomaterial accounts for 10% of the absolute dry weight of the biomass fiber; and wherein the pH value of the cooked mixture is adjusted to 12 using NaOH aqueous solution before carrying out the hot grinding treatment;

3. pushing the cooked mixture between the grinding discs of the defibrator for hot grinding treatment, wherein the rotating speed for the hot grinding is 2880 rpm, and the time for the hot grinding treatment is 6 h; and

4. filtering the hot-ground slurry followed by paving it into a plate blank, and hot pressing the plate blank to obtain the nanomaterial-biomass fiber composite, wherein the hot pressing temperature is 160° C., the hot pressing time is 180 min, and the hot pressing pressure is 4 MPa.

### EXAMPLE 13

1. Cutting or slicing the biomass fiber, and then drying it to the extent that the moisture content of the biomass fiber is less than 10%, wherein the biomass fiber comprises a mixture of bamboo and bamboo processing residues;

2. adding nanomaterial into the biomass fiber and mixing them to obtain a mixture, and conveying the mixture to the preheating cylinder of a defibrator for cooking treatment, wherein the cooking temperature in the preheating cylinder is 220° C., the steam pressure is 6 MPa and the cooking time is 50 min; the nanomaterial is nano-graphene, and the nanomaterial accounts for 12% of the absolute dry weight of the biomass fiber; and wherein the pH value of the cooked mixture is adjusted to 13 using NaOH aqueous solution before carrying out the hot grinding treatment;

3. pushing the cooked mixture between the grinding discs of the defibrator for hot grinding treatment, wherein the rotating speed for the hot grinding is 2880 rpm, and the time for the hot grinding treatment is 6 h; and

4. filtering the hot-ground slurry followed by paving it into a plate blank, and hot pressing the plate blank to obtain the nanomaterial-biomass fiber composite, wherein the hot pressing temperature is 160° C., the hot pressing time is 180 min, and the hot pressing pressure is 4 MPa.

### EXAMPLE 14

1. Cutting or slicing the biomass fiber, and then drying it to the extent that the moisture content of the biomass fiber is less than 10%, wherein the biomass fiber comprises a mixture of wood, bamboo and corresponding processing residues;

2. conveying the nanomaterial to the discharge valve of the defibrator via a pipe and injecting it into the discharge valve via a nozzle so as to be mixed with the biomass fiber to obtain a mixture, and conveying the mixture to the preheating cylinder of the defibrator for cooking treatment, wherein the cooking temperature in the preheating cylinder is 240° C., the steam pressure is 8 MPa and the cooking time is 55 min; the nanomaterial is nano-carbon fiber, and the nanomaterial accounts for 15% of the absolute dry weight of the biomass fiber; and wherein the pH value of the cooked mixture is adjusted to 14 using NaOH aqueous solution before carrying out the hot grinding treatment;

3. pushing the cooked mixture between the grinding discs of the defibrator for hot grinding treatment, wherein the rotating speed for the hot grinding is 2880 rpm, and the time for the hot grinding treatment is 6 h; and

4. filtering the hot-ground slurry followed by paving it into a plate blank, and hot pressing the plate blank to obtain the nanomaterial-biomass fiber composite, wherein the hot pressing temperature is 160° C., the hot pressing time is 180 min, and the hot pressing pressure is 4 MPa.

### EXAMPLE 15

1. Cutting or slicing the biomass fiber, and then drying it to the extent that the moisture content of the biomass fiber is less than 10%, wherein the biomass fiber comprises a mixture of wood, bamboo and corresponding processing residues;

2. conveying the nanomaterial onto a wood chip at the feed inlet of the grinding chamber of the defibrator via a delivery pump, conveying it into the continuous discharge valve of the grinding chamber of the defibrator via a gear pump to be mixed with the biomass fiber to obtain a mixture, and conveying the mixture to the preheating cylinder of the defibrator for cooking treatment, wherein the cooking temperature in the preheating cylinder is 250° C., the steam pressure is 10 MPa and the cooking time is 60 min; the nanomaterial is carbon nanotube, and the nanomaterial accounts for 20% of the absolute dry weight of the biomass fiber; and wherein the pH value of the cooked mixture is adjusted to 14 using NaOH aqueous solution before carrying out the hot grinding treatment;

3. pushing the cooked mixture between the grinding discs of the defibrator for hot grinding treatment, wherein the rotating speed for the hot grinding is 2880 rpm, and the time for the hot grinding treatment is 6 h; and;

4. filtering the hot-ground slurry followed by paving it into a plate blank, and hot pressing the plate blank to obtain the nanomaterial-biomass fiber composite, wherein the hot pressing temperature is 160° C., the hot pressing time is 180 min, and the hot pressing pressure is 4 MPa.

Product Structure and Performance Characterization

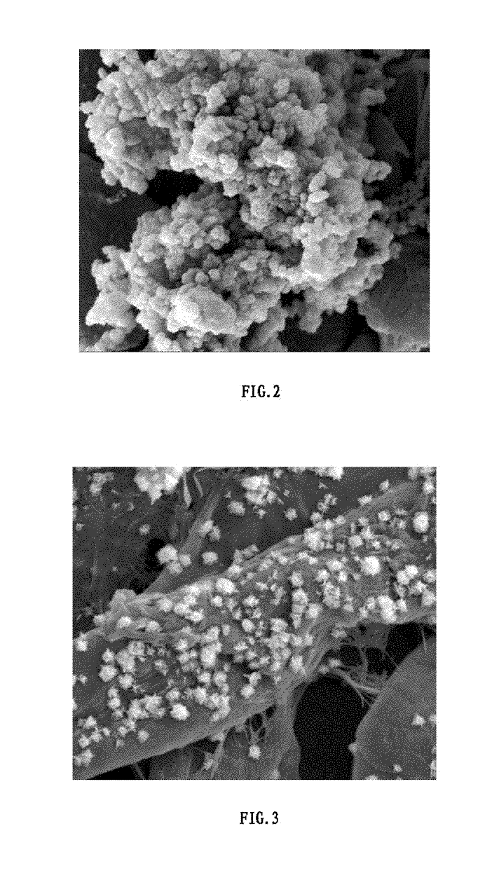

FIG. 2 is a scanning electron micrograph of a TiO₂ nanomaterial-biomass fiber composite prepared in Example 1 of the present invention. Referring to FIG. 2, it can be observed that a large amount of inorganic nanomaterials, namely nano-TiO₂, are loaded onto the biomass fibers.

FIG. 3 is a scanning electron micrograph of a ZnO nanomaterial-biomass fiber composite prepared in Example 2 of the present invention. Referring to FIG. 3, it can be observed that a large amount of inorganic nanomaterials, namely nano-ZnO, are loaded onto the biomass fibers.

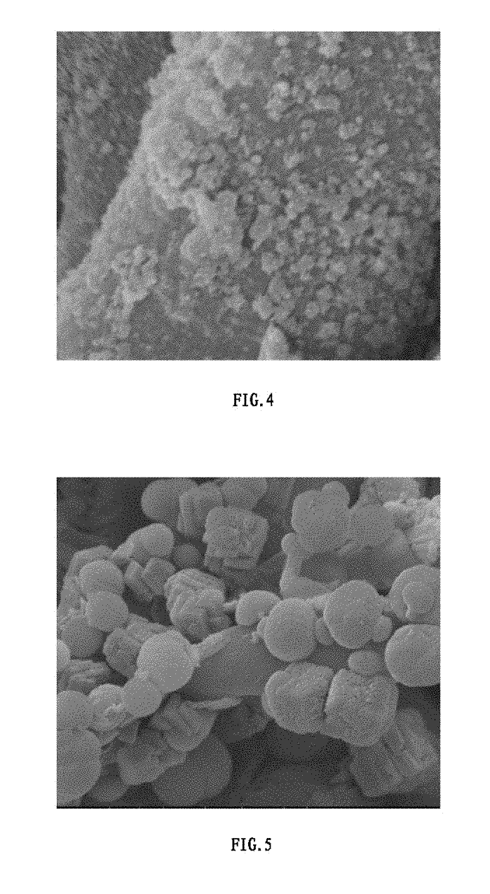

FIG. 4 is a scanning electron micrograph of a Fe₃O₄ nanomaterial-biomass fiber composite prepared in Example 5 of the present invention. Referring to FIG. 4, it can be observed that a large amount of inorganic nanomaterials, namely nano-Fe₃O₄, are loaded onto the biomass fibers.

FIG. 5 is a scanning electron micrograph of a CaCO₃ nanomaterial-biomass fiber composite prepared in Example 6 of the present invention. Referring to FIG. 5, it can be observed that a large amount of inorganic nanomaterials, namely nano-CaCO₃, are loaded onto the biomass fibers.

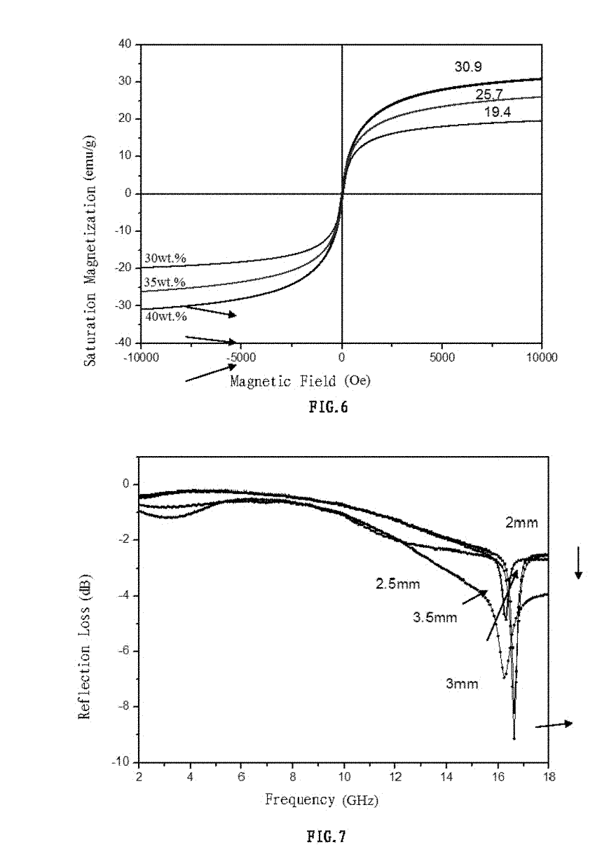

FIG. 6 is a hysteresis loop of a Fe₃O₄ nanomaterial-biomass fiber composite prepared in Example 5 of the present invention. Referring to FIG. 6, where the abscissa is the magnetic field (Oe) and the ordinate is the saturation magnetization (emu/g). Three samples having Fe₃O₄ concentrations of 30 wt %, 35 wt % and 40 wt % respectively were taken from the Fe₃O₄ nanomaterial-biomass fiber composite prepared in Example 5, and were measured at room temperature by a vibrating sample magnetometer. In FIG. 6, the specific curve is shown, with the saturation magnetization of the sample varying with the concentration of Fe₃O₄. When the Fe₃O₄ concentration is 30 wt %, the saturation magnetization thereof is 19.4 emu/g; when the Fe₃O₄ concentration is 35 wt %, the saturation magnetization thereof is 25.7 emu/g; and when the Fe₃O₄ concentration is 40 wt %, the saturation magnetization thereof is 30.9 emu/g. It can be seen from FIG. 6 that the composite material successfully inherits the magnetic property of Fe₃O₄, and as the concentration of Fe₃O₄ increases from 30 wt % to 40 wt %, the saturation magnetization also increases, which demonstrates that the Fe₃O₄ nanomaterial-biomass fiber composite have excellent magnetic properties.

FIG. 7 is a graph showing the changing of the reflection loss frequency of the ZnO nanomaterial-biomass fiber composite prepared in Example 2 of the present invention. Referring to FIG. 7, from the ZnO nanomaterial-biomass fiber composite prepared in Example 2 of the present invention, four samples only different in thickness, with the other parameters being the same, were taken, the thicknesses thereof being 2 mm, 2.5 mm, 3 mm, and 3.5 mm respectively, and they were subjected to a reflection loss-frequency test. It can be seen from FIG. 7 that, within a certain frequency range, the absorption effect of the sample increases as the thickness of the material increases.

When the sample thickness is 2 mm, the maximum attenuation is −5 dB at about 16.4 GHz; when the sample thickness is 2.5 mm, the maximum attenuation is −7 dB at about 16.2 GHz; when the sample thickness is 3 mm, the maximum attenuation is −8 dB at about 16.8 GHz; and when the sample thickness is 3.5 mm, the maximum attenuation is −9 dB at about −16.8 GHz. It can be seen from FIG. 7 that the composite material successfully inherits the wave absorption property of ZnO, which demonstrates that the ZnO nanomaterial-biomass fiber composite has good wave absorption properties.

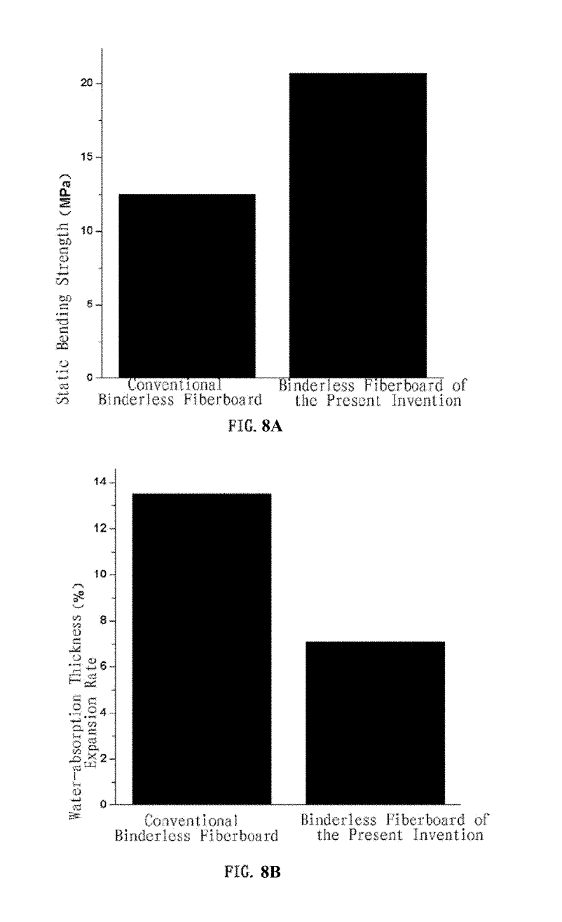

FIGS. 8A and 8B show the comparisons between the mechanical properties as well as thickness swelling rate of water absorption of the nanomaterial-biomass fiber composite (i.e., a binderless fiberboard) prepared in Example 11 of the present invention and a conventional binderless fiberboard. Referring to FIG. 8A, compared with the 12.5 MPa static bending strength of the conventional binderless fiberboard, the static bending strength of the binderless fiberboard prepared in Example 11 of the present invention increases to 20.7 MPa. Referring to FIG. 8b, as compared with the 13.5% thickness swelling rate of the conventional binderless fiberboard, the thickness swelling rate of the binderless fiberboard prepared in Example 11 of the present invention reduces to 7.1%. The above results indicate that the binderless fiberboards of the present invention have a better performance.

The numerical values set forth in these examples do not limit the scope of the present invention unless otherwise specified. In all the examples shown and described herein, unless otherwise specified, any specific value should be interpreted as illustrative merely but not a limitation, and thus, other examples of the illustrative embodiments may have different values.

Finally, it should be noted that, the above examples are only used to illustrate the technical solutions of the present invention, rather than limit the same; although the present invention has been described in detail with reference to the foregoing examples, those skilled in the art should understand that, it is still possible to modify the technical solutions described in the foregoing examples or equivalently replace part or all of the technical features therein; and these modifications or replacements do not deviate the essence of the corresponding technical solutions from the scope of the technical solutions of the examples of the present invention, and they should be all covered by the scope of the claims and the description of the present invention.

what is claimed is:

1. A nanomaterial-biomass fiber composite, which is prepared by: cutting or slicing biomass fibers and drying; mixing dried biomass fibers with a nanomaterial, and conveying them to a preheating cylinder of a defibrator for cooking treatment; and
pushing a cooked mixture between grinding discs of the defibrator for hot grinding treatment, and then hot pressing a resulting material to obtain the nanomaterial-biomass fiber composite.

2. The nanomaterial-biomass fiber composite according to claim 1, wherein the biomass fiber is selected from at least one of wood, bamboo, processing residues, crop waste, and Gramineae weed.

3. The nanomaterial-biomass fiber composite according to claim 2, wherein the crop waste is at least one of rice straw, wheat straw, corn straw, cotton straw and bagasse;
and wherein the Gramineae weed is at least one of reed and miscanthus.

4. The nanomaterial-biomass fiber composite according to claim 1, wherein the nanomaterial is selected from at least one of nano-TiO₂, nano-ZnO, nano-Ag, nano-SiO₂, nano-Fe₃O₄, nano-CaCO₃, nano-Al₂O₃, nano-Mg(OH)₂, nano-Al(OH)₃, nano-CeO₂, nano-MnO_{2,} nano-cellulose, nano-graphene, nano-carbon fiber and carbon nanotube.

5. The nanomaterial-biomass fiber composite according to claim 1, wherein a weight of the nanomaterial accounts for 0.01%-20% of ae absolute dry weight of the biomass fibers.

6. The nanomaterial-biomass fiber composite according to claim 1, wherein the nanomaterial-biomass fiber composite is free of adhesive.

7. The nanomaterial-biomass fiber composite according to claim 1, wherein the nanomaterial-biomass fiber composite is free of auxiliary agent.

8. A method of preparing a nanomaterial-biomass fiber composite, comprising steps of:
cutting or slicing biomass fibers, and then drying the biomass fibers so that a moisture content of the biomass fibers is less than 10%;
mixing dried biomass fibers with a nanomaterial to obtain a mixture, and conveying the mixture to a preheating cylinder of a defibrator for cooking treatment;
pushing a cooked mixture between grinding discs of the defibrator for hot grinding treatment to obtain a slurry of the nanomaterial-biomass fiber composite; and
filtering a hot-grinded slurry followed by paving it into a plate blank, and hot pressing the plate blank to obtain the nanomaterial-biomass fiber composite.

9. The preparation method according to claim 8, wherein in the mixing step, a cooking temperature is 100-250° C., a steam pressure is 0.01-10 Mpa, and a cooking time is 1-60 minutes.

10. The preparation method according to claim 8, wherein in the pushing step, a rotating speed for the hot grinding treatment is 500-3000 rpm, and a time for the hot grinding treatment is 1-24 hours.

11. The preparation method according to claim 8, wherein in the filtering step, a hot pressing temperature is 100-220° C., a hot pressing time is 10-300 minutes, and a hot pressing pressure is 1-8 MPa.

12. The method according to claim 8, wherein the step of mixing the dried biomass fibers with the nanomaterial is carried out by directly adding the nanomaterial to the dried biomass fibers and mixing them.

13. The preparation method according to claim 8, wherein the step of mixing the dried biomass fibers with the nanomaterial is carried out by conveying the nanomaterial to a discharge valve of the defibrator via a pipe and injecting the nanomaterial into the discharge valve via a nozzle so as to mix the nanomaterial with the dried biomass fibers.

14. The preparation method according to claim 8, wherein the step of mixing the dried biomass fibers with the nanomaterial is carried out by conveying the nanomaterial onto a wood chip at a feed inlet of a grinding chamber of the defibrator via a delivery pump, and conveying the nanomaterial into a continuous discharge valve of the grinding chamber of the defibrator via a gear pump so as to mix the nanomaterial with the dried biomass fibers.

15. The preparation method according to claim 8, further comprising a step of adjusting a pH value of the cooked mixture to 1-14 before carrying out the hot grinding treatment in the pushing step.

16. A nanomaterial-biomass fiber composite, which is prepared by a method comprising steps of:
cutting or slicing biomass fibers, and then drying the biomass fibers so that a moisture content of the biomass fibers is less than 10%;
mixing dried biomass fibers with a nanomaterial to obtain a mixture, and conveying the mixture to a preheating cylinder of a defibrator for cooking treatment;
pushing a cooked mixture between grinding discs of the defibrator for hot grinding treatment to obtain a slurry of the nanomaterial-biomass fiber composite; and
filtering a hot-grinded slurry followed by paving it into a plate blank, and hot pressing the plate blank to obtain the nanomaterial-biomass fiber composite.

17. The nanomaterial-biomass fiber composite according to claim 16, wherein in the mixing step, a cooking temperature is 100-250° C., a steam pressure is 0.01-10 Mpa, and a cooking time is 1-60 minutes.

18. The nanomaterial-biomass fiber composite according to claim 16, wherein in the pushing step, a rotating speed for the hot grinding treatment is 500-3000 rpm, and a time for the hot grinding treatment is 1-24 hours.

19. The nanomaterial-biomass fiber composite according to claim 16, wherein in the filtering step, a hot pressing temperature is 100-220° C., a hot pressing time is 10-300 minutes, and a hot pressing pressure is 1-8 MPa.

20. The nanomaterial-biomass fiber composite according to claim 16, further comprising a step of adjusting a pH value of the cooked mixture to 1-14 before carrying out the hot grinding treatment in the pushing step.
